(19) United States
(12) Patent Application Publication
(10) Pub. No.: US 2007/0051048 A1
(43) Pub. Date: Mar. 8, 2007

(54) Sliding door comprising a frame and a guiding mechanism

(75) Inventors: Dieter Krohn, Wakendorf (DE); Guenter E. Hoedtke, Pinneberg (DE)

Correspondence Address: Kenneth L. Mitchell;Woodling, Krost and Rust, 9213 Chillicothe Road, Kirtland, OH, 44094, US

(73) Assignee: Hoedtke GmbH & Co. KG Metall-und Lasertechnik, 25421 Pinneberg (DE)

(21) Appl. No.: 10/565,720

(22) PCT Filed: Jul. 29, 2004
(86) PCT No.: PCT/EP04/08506

§ 371 Date: Sep. 6, 2006

(30) Foreign Application Priority Data
Jul. 29, 2003 (DE) 103 34 871.9

(51) Int. Cl. E05D 15/06

(52) U.S. Cl. 49/413

(57) ABSTRACT

Disclosed is a sliding door (10) comprising a door leaf, a frame (12), a guiding mechanism (16, 18) for the door leaf (14) that can be moved within the guiding mechanism (16, 18) between an open position and a closed position, and means for stiffening at least some areas of the frame (12) in the closed position in which the frame (12) covers at least some areas of the edge region of the first and/or second face (44, 48) of the door leaf (14). The invention is characterized in that the door leaf (14) is provided with engaging means (34) while the frame (12) is provided with receiving means (122), said means engaging into each other essentially only in the closed position and generating a force F₂ that acts perpendicular to the sliding direction and stiffens the associated area of the frame (12).

The invention pertains to a sliding door with a frame and a guide of the type indicated in the introductory clause of Claim 1.

Sliding doors of various designs are known, and they are used for a wide variety of purposes. The known sliding doors have a guide for a door leaf, which can slide in the guide between an open position and a closed position. A locking device is also provided, which firmly locks the door in the closed position. A frame is provided, which covers at least part of the edge area of the first and/or second side of the door leaf when the leaf is in the closed position.

The frame consists primarily of an upper and a lower transverse stringer and two lateral, longitudinal frame parts. The door leaf passes through the first longitudinal frame part as it is being pushed from the open position to the closed position. When the door leaf is in the closed position, its forward edge rests against the second longitudinal frame part.

The problem with the known sliding doors is that the loads to which they can be subjected, such as the loads exerted by gas pressures, for example, are severely limited. The reason for this is that, if the door is made of sheet metal, for example, it will, when in the locked position, be deformed immediately if there is a high pressure differential between the space in front of the sliding door and the space behind it. Although it would be possible to build the frame and the door leaf out of flexurally stiff material, this would significantly increase the weight of the unit. In addition, the first longitudinal frame part continues to represents a weak point, because, when the door leaf is moved from the open position to the closed position, it still must pass through this first longitudinal frame part.

Sliding doors of the basic type in question are known from U.S. Pat. No. 5,673,874 A and from U.S. Pat. No. 5,181,677. The stiffening means are formed here by the guide itself, which is designed as a set of interlocking profiles. The disadvantage here is that a great amount of force is necessary to move the sliding door, because a great deal of friction is produced as a result of the interlocking profiles, which extend over the entire distance the door must slide.

WO 90/13,725 A1 describes a sliding door with a frame. The forward edge of the door leaf of the sliding door, when in the closed position, rests against a second longitudinal frame part. The sliding door is pushed through a first longitudinal frame part.

The invention is based on the task of improving a sliding door with a frame and a guide according to the introductory clause of Claim 1 in such a way that a flexurally stiff design can be obtained by a light-weight construction method.

This task is accomplished by the characterizing features of the Claim 1 in conjunction with the features of the introductory clause.

The subclaims describe advantageous elaborations of the invention.

The invention is based on the realization that it is possible to stiffen the frame in an simple manner by the use of stiffening elements, which are attached to the door leaf and/or to the frame and which engage with each other or rest against each other essentially only when the door leaf is in the closed position in such a way that a force acting transversely to the sliding direction is generated.

According to the invention, the door leaf therefore has engaging means, and the frame has receiving means. The engaging means and the receiving means engage with each other essentially only when the door leaf is in the closed position and thus generate a force which acts transversely to the sliding direction and thus stiffens the associated area of the frame.

The engaging means preferably has at least one bevel, and the receiving means has a cooperating bevel. As a result of the engagement between these bevels, a force acting on the door leaf transversely to the sliding direction generates the transverse reaction force required to stiffen the frame.

The bevels also produce the result that the size of the contact surfaces is increased and thus the load per unit area is decreased. Powerful forces can therefore be transmitted even though the sliding door is built by a light-weight construction method.

Especially in the aircraft industry there is an increasing demand for sliding doors which form a seal. Here there is the problem, however, that these types of sliding doors must meet certain safety requirements. The present applicant has therefore developed a locking device, which presses the door leaf against a stop, usually a seal. According to one embodiment of the invention, the locking device therefore generates the force which acts on the door leaf.

The force acting on the door leaf acts preferably only in the locked state, i.e., the state in which the locking device is braced against one side of the frame and presses the door leaf against stop means on the other side of the frame.

In the locked state, the two sides of the frame are in particular pushed apart by the force produced by the locking device. The engaging means of the door leaf and the receiving means of the frame hold the frame together in this situation, as a result of which the reactively generated transverse force acts on the frame and the leaf.

The engaging means are preferably mounted on the rear edge of the door leaf, i.e., on the edge which is in the trailing position as the leaf is being moved from the open position to the closed position. Finally, it is the first longitudinal frame part of the frame, through which the door leaf is pushed, which especially needs to be stiffened.

The receiving means of the frame are arranged adjacent to each other on the two opposing inside surfaces of the frame. The engaging means of the door leaf assigned to two of these receiving means is designed as a claw.

So that a high number of load cycles can be withstood, the stiffening means of the frame and of the door leaf offer two kinds of support—the first serving to transmit forces between the door leaf and the frame in the closed position, the second to improve the guidance of the door leaf. The first support is formed by the beveled, facing surfaces of the engaging and receiving means. The second support is formed by at least one roller, which rests against the inside surface of the frame. Several rollers can be arranged around the same axis to form a support.

According to one embodiment, the claw and the rear edge of the door leaf are connected to each other by a strap, where the strap is supported in such a way that it can move relative to the claw in a direction transverse to the sliding direction and perpendicular to the surface of the door leaf. The strap must be able to move relative to the claw to compensate, for example, for the closing movement of the door leaf perpendicular to the sliding direction which occurs when the door leaf is being locked in the closed position.

The roller is rotatably supported in the end of the claw facing away from the door leaf.

The stiffening means located in the frame have recesses, which cooperate with the claws and in which the claws engage when the door leaf is in the closed position.

The receiving means of the frame and the engaging means of the door leaf are arranged symmetrically with respect to the plane in which the door leaf slides.

The frame preferably has a first and a second longitudinal frame part, where, during the sliding movement of the door leaf from the open position to the closed position and vice versa, the door leaf is pushed through the first longitudinal frame part, and where the forward edge of the door leaf, when the door leaf is in the closed position, rests against the second longitudinal frame part.

The receiving means of the frame are provided in the first longitudinal frame part, and the engaging means of the door leaf are located only on the rear edge of the door leaf, so that the stiffening means are effective only in the area of the first longitudinal frame part. The other parts of the frame, namely, the upper transverse beam and the lower transverse beam and the second longitudinal frame part are stiffened by different stiffening means. For example, the guides for the door leaf are installed in the upper and lower transverse beams, and a lateral stringer is provided in the second longitudinal frame part to stiffen it.

The frame is preferably built by a light-weight construction method and is made of a material such as sheet metal.

Additional advantages and possible applications of the present invention can be derived from the following description in conjunction with the exemplary embodiments presented in the drawings.

The terms and associated reference numbers contained in the list of reference numbers given below are used in the specification, in the claims, in the abstract, and in the drawings. In the drawings,

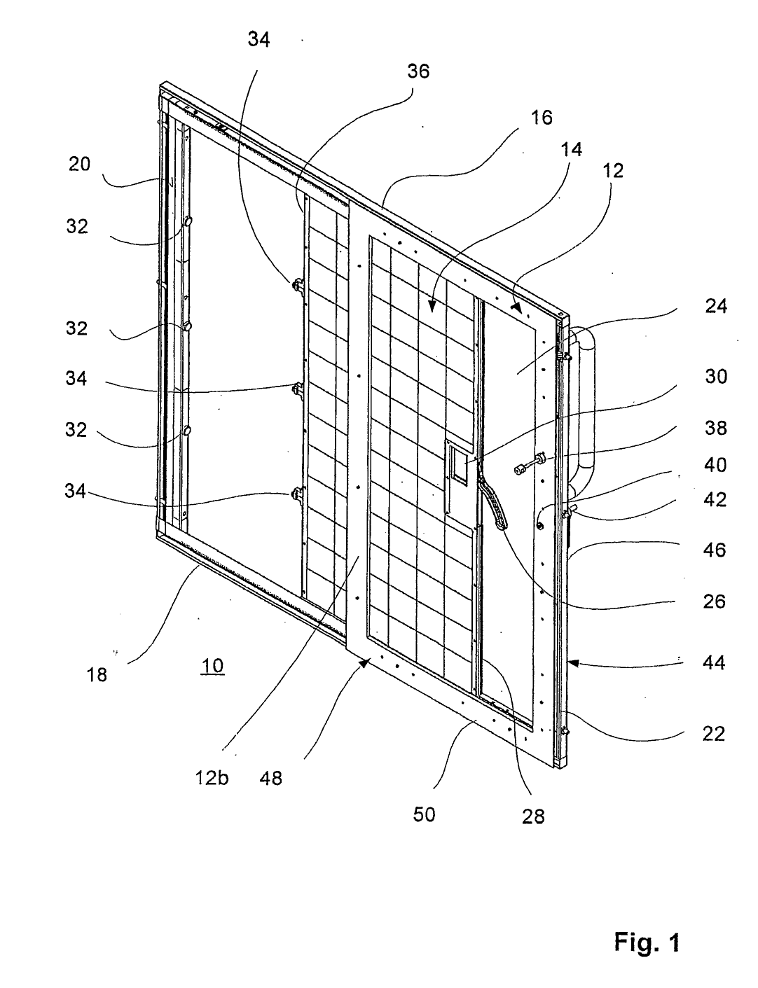

FIG. 1 shows a schematic diagram, in perspective, of a sliding door with guides, lateral stringers, and a frame;

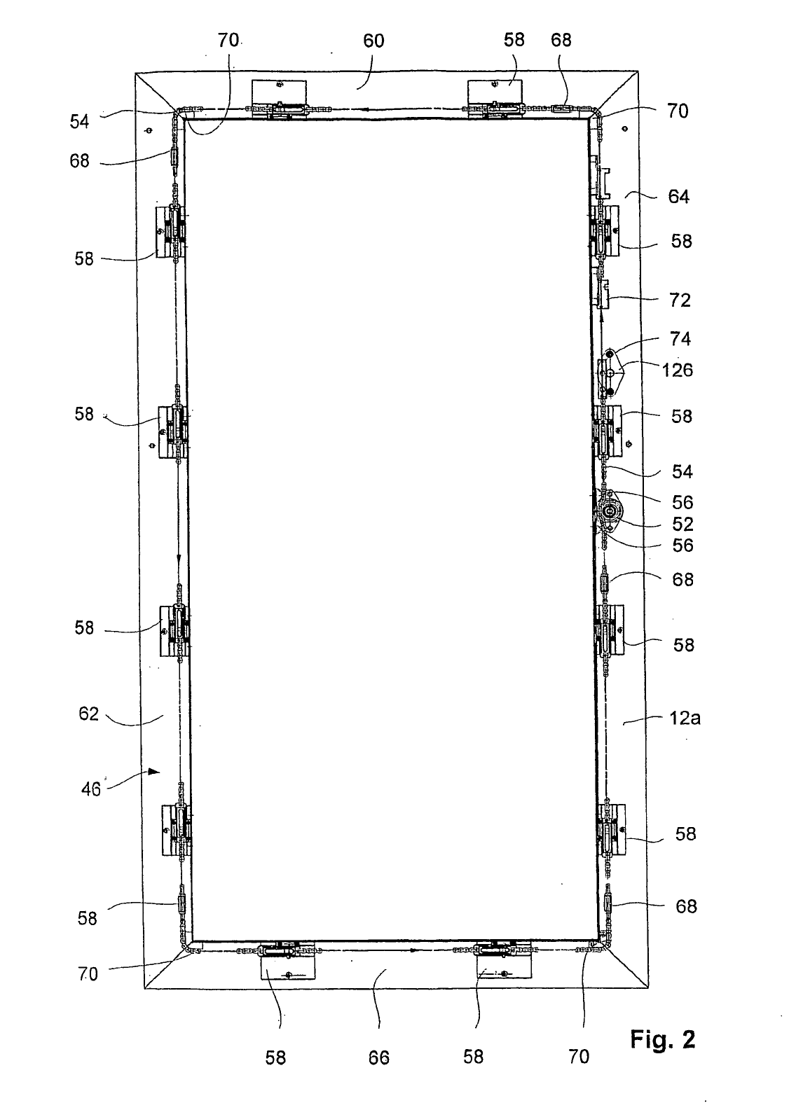

FIG. 2 shows a longitudinal cross section of the second frame part of the frame, in which a locking device for the door leaf of the sliding door is installed;

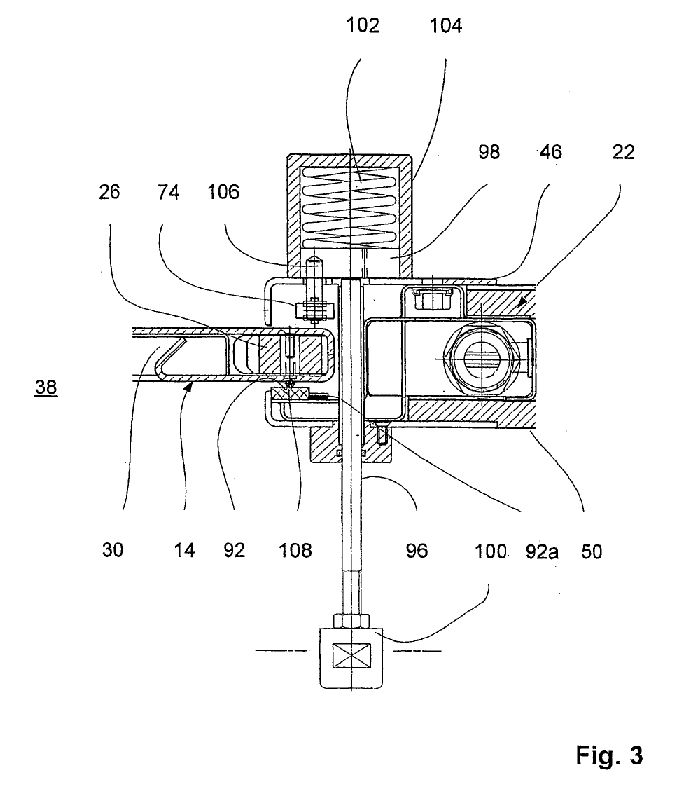

FIG. 3 shows a transverse cross section of a safety sensor mounted in the frame in the closed position of the door leaf of the sliding door;

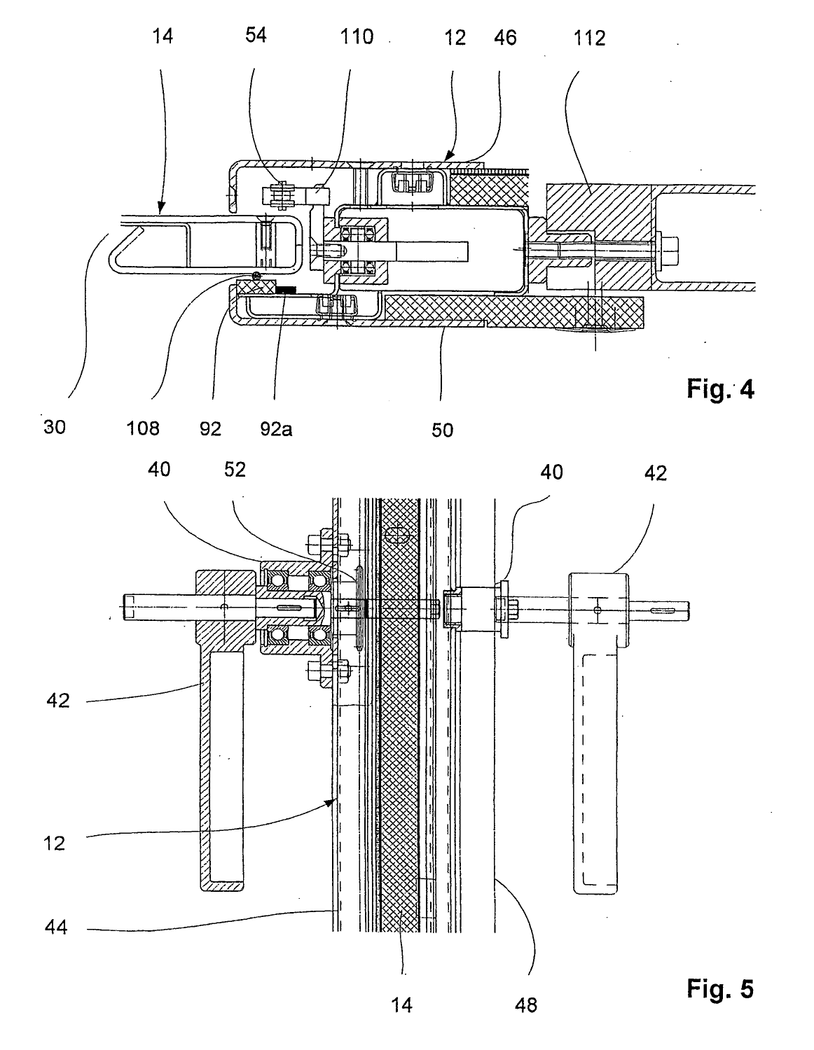

FIG. 4 shows a transverse cross section through a longitudinal frame part (stringer) of the frame in the closed position of the door leaf, which is equipped with a sensor;

FIG. 5 shows a longitudinal cross section through the frame with a handle as part of the locking device and with a door leaf in the closed position;

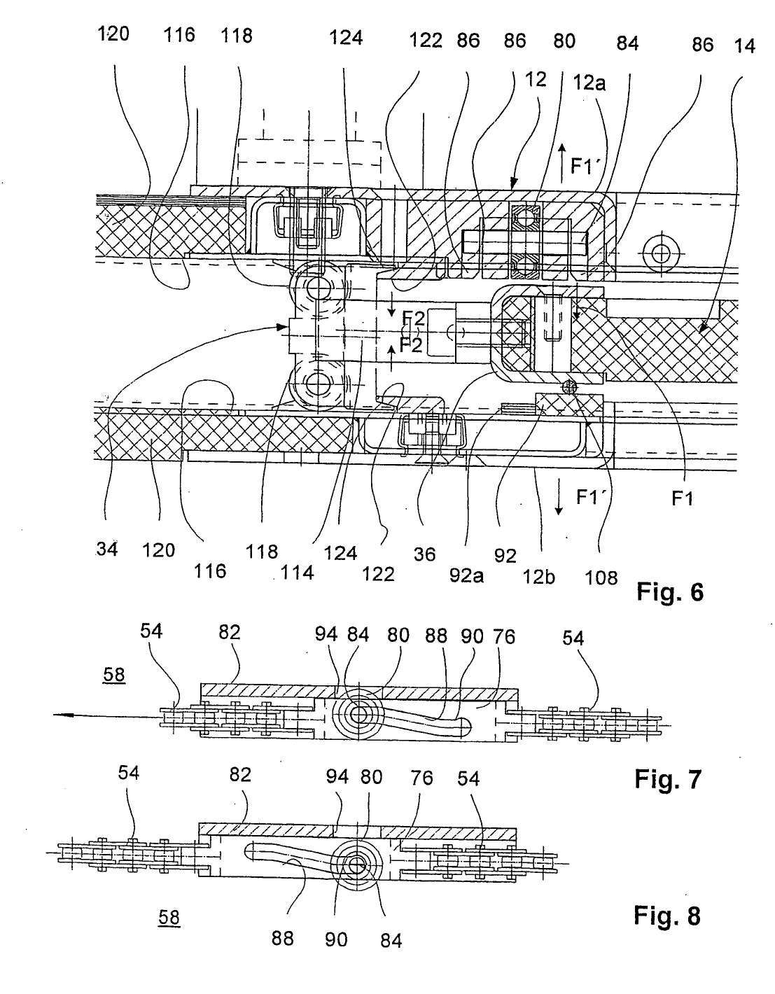

FIG. 6 shows a transverse cross section through a longitudinal frame part (stringer) of the frame, in which the edge of the door leaf one the side facing away from the handle engages when in the closed position;

FIG. 7 shows a longitudinal cross section through a motion converter, which forms part of the locking device, with the locking element in the free position;

FIG. 8 shows a longitudinal cross section through a motion converter, which forms part of the locking device, with the locking element in the hold position;

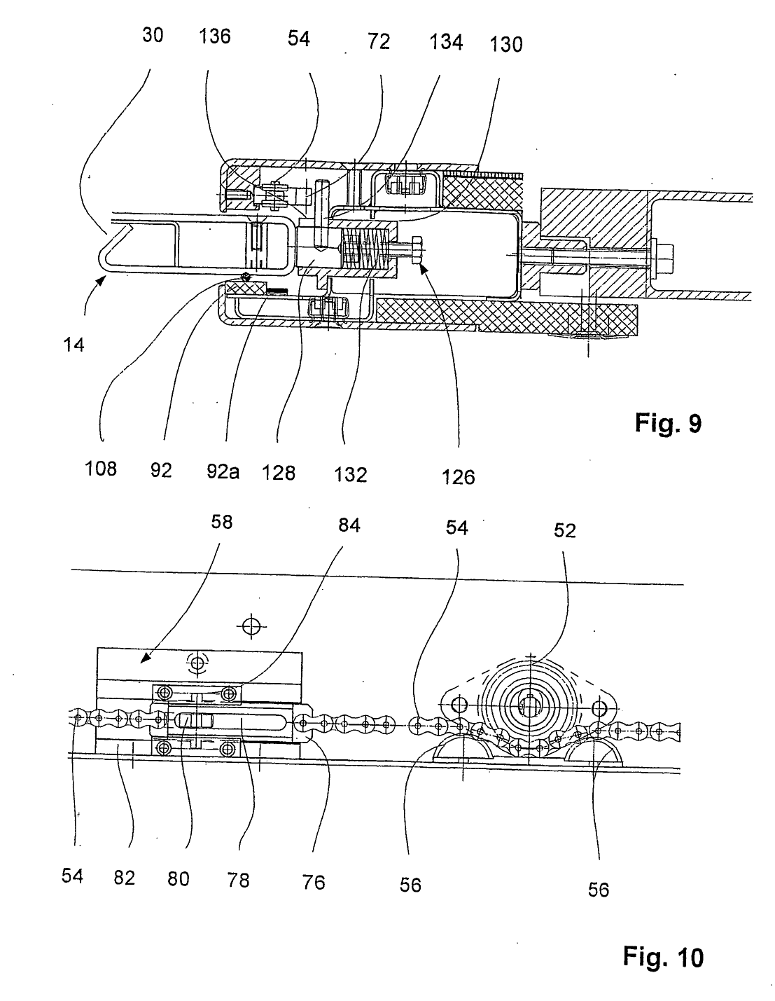

FIG. 9 shows a longitudinal cross section through a longitudinal frame part (stringer) of the frame in the closed position of the door leaf with a blocking device; and

FIG. 10 shows a schematic plan view of the second frame part in the area of the handle, where both a pinion connected to the handle and the motion converter of the locking device with the locking element can be seen.

FIG. 1 shows a perspective view of a sliding door 10 according to the invention. The sliding door 10 consists of a frame 12, a door leaf 14, an upper guide 16, and a lower guide 18.

The lower and upper guides 16, 18 form the upper and lower boundaries of the frame 12. Stiffening stringers 20, 22 are also provided at the sides to connect the upper and lower guides 16, 18 to each other. That is, the lateral stiffening stringer 22 connects the free ends of the upper and lower guides 16, 18 on the right, and the lateral stiffening stringer 20 connects the free ends on the left. The upper and lower guides 16, 18 extend between the two stiffening stringers 20, 22, and the door leaf 14 extends between the upper and lower guides 16, 18.

When the door leaf 14 according to FIG. 1 is located all the way to the left, the frame 12 forms the boundary of a walk-through opening 24. The sliding door 10 is located now in its “open” position.

When the door leaf 14 is all the way to the right in FIG. 1, the door leaf is located completely within the frame 12, and the sliding door 10 is in its “closed” position.

The door leaf 14 is supported in the upper guide 16 and in the lower guide 18 with the freedom to slide between its open position and its closed position.

The door leaf 14 has guide rollers (not shown here), which engage in the upper guide 16 and in the lower guide 18, and which make it possible for the door leaf 14 to slide easily. In addition, the sliding door 10 is produced by methods which ensure that it is light in weight. The door leaf 14 is filled with sound-damping filler material such as plastic honeycomb, which is covered with sound-damping tiles. The surface of the leaf is also provided with material to protect it from mechanical damage.

On the side of the leaf facing the walk-through opening 24, a door handle 26, which can be folded into and out of the door leaf 14, is supported pivotally at its upper end. In its inward-pivoted position, the door handle 26 is flush with the forward edge 28 of the door leaf 14, i.e., the edge facing the walk-through opening 24. As a result, it is easy for a user to grip the door handle 26 and use it to move the door leaf 14 from the open position to the closed position.

The door handle 26 must be folded inward before the door is fully closed in order to prevent the hand of the user from being caught. A recess is therefore introduced into the door leaf 14 on each side of the door leaf 14, adjacent to the door handle 26. These recesses serve as grips 30, which can be used to push the door leaf 14 the rest of the way closed.

On the side facing the door leaf 14, the lateral stiffening stringer 20 has rubber bumpers 32, which interact with the door leaf 14. A stiffening claw 34 is assigned to each of the rubber bumpers 32. These claws are attached to the rear edge 36 of the door leaf 14, i.e., the edge which faces the lateral stiffening stringer 20. The function of the stiffening claws 34 is explained in greater detail below in conjunction with FIG. 6.

The upper and lower guides 16, 18, together with the stiffening stringers 20, 22 and the frame 12, are built into an existing wall, such as the wall of an aircraft. Parts of this wall are extended and tightly sealed to the upper and lower guides 16, 18. One such wall part starts next to the frame 12 and extends to the lateral stiffening stringer 20 in such a way that the area next to the frame 12 in which the door leaf 14 travels will not be obstructed, while at the same time the area in question will be tightly sealed.

FIG. 1 also shows safety sensor 38, which is installed in the area of the frame 12 covering the lateral stiffening stringer 22. This sensor therefore functions on the front side 48 of the sliding door 10. Engagements openings 40 for handles 42, furthermore, are provided in both the front and the rear of the sliding door 10. The handles 42, which serve as part of a locking device for the door leaf 14, can engage in the engagement openings 40 on each side of the frame 12. The handles 42 are designed so that each one has its own separate positive connection with its engagement opening 40 on the side.

FIGS. 2, 5, 7, 8 and 10 shows the locking device, which is mounted in a rear frame part 46 of the frame 12 on what in FIG. 1 appears as the rear surface 44 of the sliding door 10. The front side 48 of the frame 12 has a front frame part 50.

The handles 42 fit into the engagement openings 40 in the frame part 46. As a result, the handles 42 can engage with a pinion 52, which is supported rotatably on the inside surface of the frame part 46. The pinion 52 engages in a link chain 54, which serves as a force-transmitting means. As a result, the movement of a handle 42 can be transmitted via the pinion 52 to the chain 54. So that the area where the pinion 52 engages with the chain 54 can be as large as possible, two guide surfaces 56 are assigned to the pinion, one on each side. These surfaces act on the side of the chain 54 facing away from the pinion 52 and thus have the effect of pushing the chain against the pinion 52 and of guiding the chain 54 during the operation of the device (see FIG. 10).

The chain 54 connects several motion converters 58, which are distributed around the periphery of the frame part 46. All of these converters are designed in the same way. Two motion converters 58 are mounted on the upper transverse stringer 60 of the frame part 46; four converters 58 are mounted on each of the lateral stringers 62 and 64 of the frame part 46; and another two motion converters are mounted on the lower transverse stringer 66 of the frame part 46 (see FIG. 2). In addition, several chain takeups 68 are provided, which are intended to simplify installation and to make it possible to adjust the locking device in such a way that it moves uniformly and continuously between its two end positions.

In the corners of the frame part 46, the chain 54 passes around slide guides 70. In addition, two blocking means 72, 74 are integrated into the course of the chain 54, which will be discussed in greater detail below on the basis of FIGS. 3 and 9.

The motion converter 58 has a slide 76 with two ends, on both of which the chain 54 acts. In the slide there is a recess 78, in which a roller 80 is mounted. The slide 76 is supported with freedom to slide in a housing 82, which is permanently connected to the frame part 46. The roller 80 has an axle 84, which extends from both sides of the roller 80 and engages in a guide link 88 and also in the housing 82 (see FIGS. 6 and 10).

In the direction in which the slide 76 moves, the recess 78 is at least as large as the movement required to move the door leaf 14 from its free position to its hold position. The axle 84 of the roller 80 is mounted in a plane parallel to that of the frame part 46. The axle 84, however, is supported on each side of the roller 80 and of the guide link 88 in a groove 86 in the housing 82, which is perpendicular to the plane of the frame part 46. When the slide 76 is pulled in the one or the other direction, the roller 80 is therefore able to move in a direction perpendicular to that in which it is being moved by the slide (FIG. 6).

As already explained above, the door leaf 14 is locked in its closed position by the use of the handle 42. The rollers 80 of the motion converters 58 serve as the locking elements and when actuated move from a free position, in which the door leaf 14 is not held, into a hold position, in which the door leaf 14 is held in a friction-locking connection with a seal 92. For this purpose, the rollers 80 press the door leaf 14 against an elastomer, which has been inserted into the frame part 50 and which serves as the seal 92.

As a result of the pressure exerted by the rollers 80 of the motion converters 58 on the door leaf 14, a force F₁ is thus applied to the door leaf 14. The motion converters 58 are supported here against one side 12a of the frame 12, and the door leaf 14 applies the force F₁ to the seal 92, which has been inserted into the frame part 50 on the other side 12b of the frame 12. A force F₁′, which acts in opposition to the force F₁, therefore acts on the sides 12a and 12b of the frame 12. The force F₁′ presses the sides 12a and 12b of the frame 12 away from each other. To stiffen the frame 12 in particular against these forces F₁′, which are present in the locked state, stiffening means in the form of receptacles in the frame 12 and engaging means on the door leaf 14 are provided, which produce a transverse force F₂, as will be discussed later on.

The rotational movement of the handle 42 proceeds around an angle of 90° from one end position to the other end position. The slide 76 of the motion converter 58 is thus shifted in the one or the other direction. By way of the guide link 88 of the slide 76, through which the axle 84 extending from both sides of the roller 80 passes, the roller 80 is pushed from one end position to the other end position. The two end positions are illustrated in detail in FIGS. 7 and 8.

FIGS. 7 and 8 show cross-sectional views of the housing 82. The slide 76 and the chain 54 are seen from the side. Here the design of the guide link 88 can be seen clearly.

FIG. 7 shows the position which the roller 80 occupies when it is in the free position, i.e., the position in which the door leaf 14 is not being held.

FIG. 8 shows the position which the roller 80 occupies when it is in the hold position, in which it presses the door leaf 14 against the seal 92 of the frame part 50. Before the roller 80 reaches the hold position, it is guided over a slack point 90, so that the user can tell when the hold position has been reached. For this purpose, just before the hold position, the guide link 88 extends downward to a point below that which it will ultimately occupy when in the hold position, as shown in FIG. 8.

The slide 76 is bilaterally symmetric with respect to its direction of movement. The roller 80 with its axle 84 and the groove 86 in the housing 82 are also bilaterally symmetric with respect to their direction of movement.

Several rollers 80 are arranged around a single axis to form both a support and a maintenance-free ball bearing.

The housing 82 has an opening 94 assigned to the roller 80, so that the roller 80 can move unhindered into its free position (see FIG. 7). When in this free position, the roller 80 is completely inside the motion converter 58 and therefore inside the slide 76 and the housing 82.

The housing 82 of each motion converter 58 is screwed to the frame part 46.

FIG. 3 shows a cross section through the frame 12 and the lateral stiffening stringer 22 at the level of the safety sensor 38 with the door leaf in the closed position. The safety sensor 38 comprises a rod 96, the length of which can be adjusted by the use of a thread, and which is connected at one end to a piston 98 and at the other end to a feeler head 100. The piston 98 has a blocking pin 106, which, when in the position shown in FIG. 3, engages in the blocking means 74 and thus blocks the actuating mechanism of the locking device, this mechanism consisting of the chain 54, the pinion 52, and the motion converters 58.

The piston 98 is able to move in the cylinder 104 against the force of the spring 102 from the blocking position shown in FIG. 3 to a position which releases the blocking means 74. Thus the blocking pin 106 will travel completely out of the blocking means 74 and release the actuating mechanism. The safety sensor 38 is moved from the blocking position into the previously described position which releases the actuating mechanism by an object acting against the feeler head 100, such as a sleeping container present in the freight compartment of an aircraft.

FIG. 3 shows a cross section of the two frame parts 46 and 50 of the frame 12, where a groove in the frame part 50 carries the seal 92. The seal 92 has been introduced in the form of a tape. A sealing lip 108, which is attached to the door leaf 14, works in conjunction with the seal 92. This lip is welded to the front surface 48 of the door leaf 14 in the area of the seal 92 and extends all the way around the periphery of the door leaf 14. In addition, the recessed grip 30 and the mounting of the door handle 26 in the door leaf 14 can also be seen.

The lateral stringer 22 is stiffened by longitudinal and transverse plates and can absorb a considerable amount of force, even if these plates are only thin sheets of titamum.

Directly adjacent to the seal 92 is a fire blocker 92a, also extending around the periphery and permanently installed on the frame 12. When exposed to heat, this fire blocker foams up and prevents leaks from developing between the front and rear sides 44, 48 of the door leaf 14 when the door leaf 14 is closed and locked

FIG. 4 shows another transverse cross section through the longitudinal stringer 22 and the frame 12 in the closed position of the door leaf 14. We can see here a lever 110, connected to the chain 54; the lever interacts with an electrical signal transmitter (not shown). In cooperation with the electrical signal transmitter, the lever 110 generates a signal when the door leaf 14 has reached its closed position and the door leaf 14 has been completely locked by the locking device. As a result, a monitoring unit installed remotely from the sliding door 10 such as in the cockpit of an aircraft can be used to detect easily whether or not the sliding door 10 is locked.

FIG. 4 also shows how the frame 12 and the lateral stiffening stringer 22 are connected to an additional wall 112.

FIG. 6 shows a transverse cross section at the level of a stiffening claw 34 of the door leaf 12. Here the door leaf 14 is in its closed position. The rear edge 36 of the present inventive door leaf 14 is connected by a strap 114 to the stiffening claw 34. The strap 114 is supported in such a way that it is free to move with respect to the stiffening claw 34 in the directions perpendicular to the sliding direction and perpendicular to the surface of the door leaf 14 but is unable to move with respect to the claw 34 in the sliding direction. The rear edge 36 of the door leaf 14 is screwed to the strap 114.

The stiffening claw 34 of the door leaf 14 has engaging means with bevels 124, which engage with cooperating bevels 122 in receptacles in the frame 12. As previously discussed, a force F₁′ acts in the locked state on the sides 12a and 12b of the frame 12. This force F₁′ presses the sides 12a and 12b away from each other. Because the stiffening claws 34 engage in the receptacles formed by the bevels, a force of reaction is created, which acts transversely to the sliding direction of the door leaf 14 and which thus has the effect of holding the sides 12a and 12b of the frame 12 together. As a result, a nonpositive connection is established between the locking device (consisting of the roller 80 and the motion converter 58), the door leaf 14, the sides 12a, 12b of the frame 12, the bevels 122 of the receptacles in the frame 12, and the bevels 124 of the stiffening claws 34 of the door leaf 14. As a result, the frame 12 is resistant to bending and therefore stiff in the area of the rear edge 36 of the door leaf.

As can be seen clearly in FIG. 6, rollers 118 are provided at the rear of the claw 34; these rollers roll along the inside surfaces 116 of the frame 12 and of the wall 120, which starts at the frame 12 and extends up as far as the lateral stiffening stringer 20. As long as the claws 34 are engaged in the receptacles of the frame 12, they provide the door leaf 14 with additional guidance as it is being pushed from the open position to the closed position and vice versa. This action of the floating claws 34 guarantees that the door leaf is guided securely during the final phase of the closing movement, just before reaching the closed and locked position.

The rollers 118 cooperate with the inside surfaces of the frame 12 to form a first support on one side, and the engaging means of the door leaf 14, designed as bevels 124, and the receptacle means of the frame 12, designed as bevels 122, cooperate to form a second support on the other side. There are thus two supports. The additional forces which occur in the locked state, such as those caused by gas pressures acting on the frame 12 and the door leaf 14, are absorbed essentially by the first support. Because the sides 12a and 12b of the frame 12 are clamped very strongly by the forces F₁′, F₁, and F₂, they are very strong.

The claws 34 with their bevels 124 engage in their assigned bevels 122 of the frame 12. The bevels 122 of the frame 12 and the bevels 124 of the claws are at an angle to a plane which is parallel to the sliding direction of the door leaf, so that, when the leaf is in the closed position, a contact surface of maximum size and strength is obtained. When the leaf is in the closed position, the frame 12 in the area of the longitudinal stringer 62 is stiffened by this design in conjunction with the forces F₁′, F₁, and F₂ generated by the locking device in the locked state. The frame 12 can absorb considerable forces without being deformed.

The play between the strap 114 and the claw 34 is at least equal to the slight offset of the door leaf 14 which occurs when the leaf is being pressed to lock it nonpositively in the sliding direction. This slight offset is attributable, for example, to the slight resilience of the seal 92 and to the bridging of the gap present between the sealing lip 108 and the seal 92 in the free position.

The bevels 122 on each of the inside surfaces of the frame in the area of the rear edge 76 of the door leaf 14 and the claws 34 are designed symmetrically with respect to the plane in which the door leaf slides.

As explained above, the force F₁ acting on the door leaf 14 is active only in the locked state, i.e., the state in which the locking device, consisting of the motion converters 58 with the rollers 80, is resting against one side 12a of the frame 12 and the door leaf 14 is being pressed against the seal 92 on the other side 12b of the frame 12. The frame 12 is thus also stiffened only in the locked state.

FIG. 9 shows a blocking device 126, which allows the rollers 80 to move from the free position to the hold position only after the door leaf 14 has reached the completely closed position. The blocking device 126 is provided with a stop piston 128, which is supported with freedom to slide back and forth in a cylinder 130 against the force of a spring 132. The stop piston 128 is connected to a blocking pin 134, which moves along with the stop piston 128 and travels along a groove 136 in the cylinder 130.

FIG. 9 shows the position of the stop piston 128 after it has moved into the cylinder 130 against the force of the spring 132. In this inward position, the blocking pin 134 releases the blocking means 72, which is connected to the chain 54.

The blocking device 126 is important, because it guarantees that the sliding door 10 can be locked only in its closed position. Only in the closed position is it guaranteed that the door leaf 14 will be locked in a leak-proof manner in the frame 12.

The sliding door 10 also has detachable retaining means, which hold the door leaf 14 in the open position. Once a certain force acting on the door leaf in the direction toward the closed position has been overcome it is possible for the door leaf to move freely toward the closed position. These retaining means are known in and of themselves and are therefore not illustrated or described in any further detail here.

The sliding door is preferably used as a safety door, which resists certain gas pressures when in the closed position. The gas pressures in question are in the range of 150-3,500 Pa.

### LIST OF REFERENCE NOS

10 sliding door
12 frame
12a side of the frame
12b side of the frame
14 door leaf
16 upper guide
18 lower guide
20 lateral stiffening stringer—left
22 lateral stiffening stringer—right
24 walk-through opening
26 door handle
28 forward edge
30 recessed grip
32 rubber bumper
34 stiffening claws
36 rear edge
38 safety sensor
40 engagement hole
42 handle
44 rear side
46 frame part—second
48 forward side
50 frame part—first
52 pinion
54 chain
56 guide surfaces
58 motion converter
60 upper transverse stringer
62 longitudinal stringer—left
64 longitudinal stringer—right
66 lower transverse stringer
68 chain takeup
70 slide guide
72 blocking means—safety stop
74 blocking means—safety sensor
76 slide
78 opening
80 roller
82 housing
84 axle
86 groove
88 guide link
90 slack point
92 seal
92a fire blocker
94 opening
96 rod
98 piston
100 feeler head
102 spring
104 cylinder
106 blocking pin
108 sealing lip
110 lever
112 additional wall
114 strap
116 inside surface of the frame
118 rollers
120 wall
122 undercut
124 elevations
126 blocking device
128 stop piston
130 cylinder
132 spring
134 blocking spring
136 groove
F₁′ force which acts on sides 12a, 12b of the frame
F₁ force which acts on the door leaf as a result of the locking device
F₂ force which acts between the surfaces 122 and 124

1. Sliding door (10) with a door leaf; with a frame (12); with a guide (16, 18) for the door leaf (14), which can be moved in the guide (16, 18) between an open position and a closed position; and with stiffening means for stiffening at least certain areas of the frame (12) when the door leaf is in the closed position, where the frame (12) covers at least certain parts of the edge area of the first and/or second side (44, 48) of the door leaf (14) when the leaf is in the closed position,
characterized in that
the door leaf (14) has engaging means (34) and the frame (12) has receiving means (122), which engage with each other essentially only in the closed position and thus generate a force (F₂) acting transversely to the sliding direction, which stiffens the associated area of the frame (12).

2. Sliding door according to claim 1, characterized in that the engaging means (34) has at least one bevel (124) and the receiving means at least one associated bevel (122), where, as a result of the engagement between these bevels (122, 124), a force (F₁′, F₁) acting on the door leaf (14) transversely to the sliding direction generates the transverse reaction force (F₂) required to stiffen the frame (12).

3. Sliding door according to claim 1, characterized in that a locking device (42, 52, 54, 56, 58) generates the force (F₁′, F₁) acting on the door leaf (14).

4. Sliding door according to claim 3, characterized in that the force (F₁′, F₁) acting on the door leaf (14) is effective only in the locked state, i.e., the state in which the locking device (42, 52, 54, 56, 58) is braced against one side (12a) of the frame (12) and presses the door leaf (14) against stop means (92) on the other side (12b) of the frame (12).

5. Sliding door according to claim 4, characterized in that, although the two sides (12a, 12b) of the frame (12) are pushed apart by the force (F₁′, F₁) generated by the locking device (42, 52, 54, 56, 58) when the door leaf is locked, the engaging means (34) of the door leaf (14) and the receiving means (122) of the frame (12) hold the frame together, as a result of which a transverse reactive force (F₂) acts on the frame and the leaf.

6. Sliding door according to claim 1, characterized in that the engaging means (34) are located on the rear edge (36) of the door leaf (14), i.e., the edge which trails as the door leaf (14) is being moved from the open position to the closed position.

7. Sliding door according to claim 1, characterized in that the receiving means of the frame (12) are arranged adjacent to each other on the two opposing inside surfaces of the frame (12).

8. Sliding door according to claim 7, characterized in that the engaging means of the door leaf (14) cooperating with the two receiving means of the frame (12) is designed as a claw (34).

9. Sliding door according to claim 8, characterized in that, next to the first support formed by the bevels (122, 124), the claw (34) has a second support, formed by at least one roller (110), which rests against an inside surface of the frame (12).

10. Sliding door according to claim 8, characterized in that the claw (34) is connected to the rear edge (36) of the door leaf (14) by a strap (114), where the strap (114) is supported so that it is free to move relative to the claw (34) in a direction perpendicular to the sliding direction of the door leaf (14).

11. Sliding door according to claim 10, characterized in that the roller (118) is supported in the end of the claw facing away from the door leaf (14).

12. Sliding door according to claim 7, characterized in that the receiving means of the frame (12) and the engaging means (34) of the door leaf (14) are designed symmetrically with respect to the plane in which the door leaf (14) slides.

13. Sliding door according to claim 1 characterized in that the frame (12) has a first and a second longitudinal frame part, where, when the door leaf (14) is being moved from the open position to the closed position and vice versa, the door leaf (14) is pushed through the first longitudinal frame part, so that the forward edge (28) of the door leaf (14) comes to rest against the second frame part when the door leaf (14) is in the closed position.

14. Sliding door according to claim 13, characterized in that the receiving means (122) of the frame (12) are arranged in the first longitudinal frame part, whereas the engaging means (34) of the door leaf are arranged only on the rear edge (36) of the door leaf (14), so that the stiffening in the closed position affects only the first longitudinal frame part.

15. Sliding door according to claim 3, characterized in that the frame (12) is produced out of sheet metal, for example, by a light-weight construction method.

16. Sliding door according to claim 2, characterized in that a locking device (42, 52, 54, 56, 58) generates the force (F₁′, F₁) acting on the door leaf (14).

17. Sliding door according to claim 5 characterized in that the engaging means (34) are located on the rear edge (36) of the door leaf (14), i.e., the edge which trails as the door leaf (14) is being moved from the open position to the closed position.

18. Sliding door according to claim 6, characterized in that the receiving means of the frame (12) are arranged adjacent to each other on the two opposing inside surfaces of the frame (12).

19. Sliding door according to claim 9, characterized in that the claw (34) is connected to the rear edge (36) of the door leaf (14) by a strap (114), where the strap (114) is supported so that it is free to move relative to the claw (34) in a direction perpendicular to the sliding direction of the door leaf (14).
